(19) United States
(12) Patent Application Publication
(10) Pub. No.: US 2018/0349110 A1
(43) Pub. Date: Dec. 6, 2018

(54) METHOD AND LAYOUT IDENTIFICATION SYSTEM FOR FACILITATING IDENTIFICATION OF A LAYOUT OF A USER INTERFACE

(71) Applicant: WIPRO LIMITED, BANGALORE (IN)

(72) Inventors: Krishna PRASAD YELLAPRAGADA, HYDERABAD (IN); VEENA SRIKANTH RAJE URS, BANGALORE (IN); MRIDUL BALARAMAN, BANGALORE (IN); RAMPRASAD KANAKATTE RAMANNA, BANGALORE (IN); VINUTHA BANGALORE NARAYANMURTHY, BANGALORE (IN)

(21) Appl. No.: 15/653,845

(22) Filed: Jul. 19, 2017

(30) Foreign Application Priority Data
May 31, 2017 (IN) 201741019160

(51) Int. Cl. G06F 9/44; G06F 3/048; G06F 17/27; G06K 9/62

(52) U.S. Cl. CPC G06F 8/38; G06F 8/34; G06K 9/6218; G06F 17/2765; G06F 3/048

(57) ABSTRACT

The method and system of present disclosure relate to facilitating identification of a layout of user interface. The method includes receiving plurality of screenshots of plurality of user-interfaces. From each of the plurality of screenshots, text elements and their corresponding actionable elements axe extracted. Further, the system identifies properties of the actionable elements in each of the plurality of screenshots which indicates the functionality of the actionable elements. Based on the properties, the system further associates the text elements, of one screenshot associated with one user-interface, with the actionable elements, of another screenshot associated with another user-interface. Further, the system creates clusters text elements and the one or more actionable elements based on the association. The clusters facilitate in the identification of the layout of the user interface. This way, the system optimizes the automation of the application by eliminating the requirement of modifying the source code of the application.

### TECHNICAL FIELD

The present subject matter is related, in general to user interface layout and more particularly, to a method and system for facilitating identification of a layout of the user interface.

### BACKGROUND

User interface provides a look and feel environment, for users interacting with any application or website. Regular use of the application makes the user familiar with its corresponding user interlaces. When the same user interacts with other application having functionally similar user interlaces with different design in terms of layouts, orchestration, syntax, format and the like, the human minds may find it difficult for interaction which in turn leads to reduction in productivity of the user.

However, in many enterprises like companies, firms and organizations, automation is implemented upon the applications to reduce the time and effort of employees in identifying the change in the user interface. Due to such automation, the system fetches the required details/information from a document and automatically populates it on the user interface of the application. However, for implementing such automation, role of software coder is required who modifies the source code of the application in order to synchronize it with the automation.

As the number of applications increase, the burden of modifying the source code also increase. Thus, the challenge of implementing the automation upon the application without modifying the source code exist in art. Moreover, the sensitive data of the enterprise is also exposed to the software coder. Thus, another challenge is to keep the enterprise data secure while implementing such automation.

### SUMMARY

Disclosed herein is a method of facilitating identification of a layout of a user interface. The method includes receiving plurality of screenshots of plurality of user-interfaces. Each screenshot of the plurality of screenshots indicate a phase associated with a workflow of an application. The method further includes extracting one or more text elements and one or more corresponding actionable elements from each of the plurality of screenshots. Further, the method includes identifying properties of the one or more actionable elements in each of the plurality of screenshots. The properties indicate functionality of the one or more actionable elements. The method further includes associating the one or more text elements, of one screenshot associated with one of the plurality of user-interfaces, with the one or more actionable elements, of another screenshot associated with another user-interface of the plurality of user-interfaces, based on the properties. Further, the method includes creating one or more clusters of the one or more text elements and the one or more actionable elements based on the association. The one or more clusters facilitates in identification of the layout of the user interface.

Further, the present disclosure relates to a layout identification system for facilitating identification of a layout of a user interface. The system comprises a processor and a memory communicatively coupled to the processor. The memory stores processor-executable instructions, which, on execution, causes the processor to receive plurality of screenshots of plurality of user-interfaces. Each screenshot of the plurality of screenshots indicate a phase associated with a workflow of an application. The processor further extracts one or more text elements and one or more corresponding actionable elements from each of the plurality of screenshots. Further, the processor identifies properties of the one or more actionable elements in each of the plurality of screenshots. The properties indicate functionality of the one or more actionable elements. Further, the processor associates the one or more text elements, of one screenshot associated with one of the plurality of user-interfaces, with the one or more actionable elements, of another screenshot associated with another user-interface of the plurality of user-interfaces, based on the properties. The processor further creates one or more clusters of the one or more text elements and the one or more actionable elements based on the association. The one or more clusters facilitates in the identification of the layout of the user interface.

Furthermore, the present disclosure relates to a non-transitory computer readable medium, including instructions stored thereon that when processed by at least one processor cause a layout identification system to perform the acts of receiving plurality of screenshots of plurality of user-interfaces. Each screenshot of the plurality of screenshots indicate a phase associated with a workflow of an application. The layout identification system further extracts one or more text elements and one or more corresponding actionable elements from each of the plurality of screenshots. Further, the layout identification system identifies properties of the one or more actionable elements in each of the plurality of screenshots. The properties indicate functionality of the one or more actionable elements. Further, the layout identification system associates the one or more text elements, of one screenshot associated with one of the plurality of user-interfaces, with the one or more actionable elements, of another screenshot associated with another user-interface of the plurality of user-interfaces, based on the properties. The layout identification system further creates one or more clusters of the one or more text elements and the one or more actionable elements based on the association. The one or more clusters facilitates in identification of the layout of the user interface.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 shows an exemplary environment for facilitating identification of a layout of a user interface in accordance with some embodiments of the present disclosure;

FIG. 2 shows a detailed block diagram illustrating a layout identification system for facilitating identification of a layout of a user interface in accordance with some embodiments of the present disclosure;

FIG. 3 shows a flowchart illustrating a method of facilitating identification of a layout of a user interface in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the spirit and the scope of the disclosure.

The terms “comprises”, “comprising”, “includes”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a system for facilitating identification of a layout of a user interface. Although, the method for facilitating the identification of the layout of the user Interface is described in conjunction with a server, the said method can also be implemented in various computing systems/devices, other than the server. The user interface provides human-computer interaction while accessing any application or a website. Although, the functionality of most of the applications in similar domain remains same, the user interface may differ from one application to another. For example, the user interface of a login page of two different online travel or ticketing applications may be different. The difference may be in the placement of the text elements or actionable elements on screen,

Due to the difference, the software developers/coders may face challenge while implementing automation in such applications. In the enterprise like companies, firms, organizations and the like, the automations are used for saving time and effort of their employees. One example of such automation may be fetching travel information (e.g., source, destination, date of travel etc.,) from an email of the employee and automatically populating the fetched information on any of the online travel application. This saves a lot of time of the employees spent for reading the email and manually inputting the details on the travel application. However, for implementing such automation, software developers/coders have to modifying the source code of each of the travel applications.

The effort of modifying the source code becomes tedious when the number of applications increases or any new application is added in the list. To overcome such issue of modifying the source code each time, the present disclosure facilitates the identification of a layout of a user interface of the application by using screenshots. The screenshots of previous or existing user interlaces associated with the applications are received and processed by the system. User interface elements like text elements and actionable elements are fetched from the screenshots and analyzed by the system. The system also learns from association between the user interface elements. This learning helps the system to train itself tor next or any new user interface of a new application. This way, the coder does not have to modify the source code of the new application. Hence, the automation is implemented without modifying the source code and also without exposing the sensitive data to the software developer/coder.

In the following detailed description of the embodiments of the disclosure, reference is made to the accompanying drawings that form a part hereof, and which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

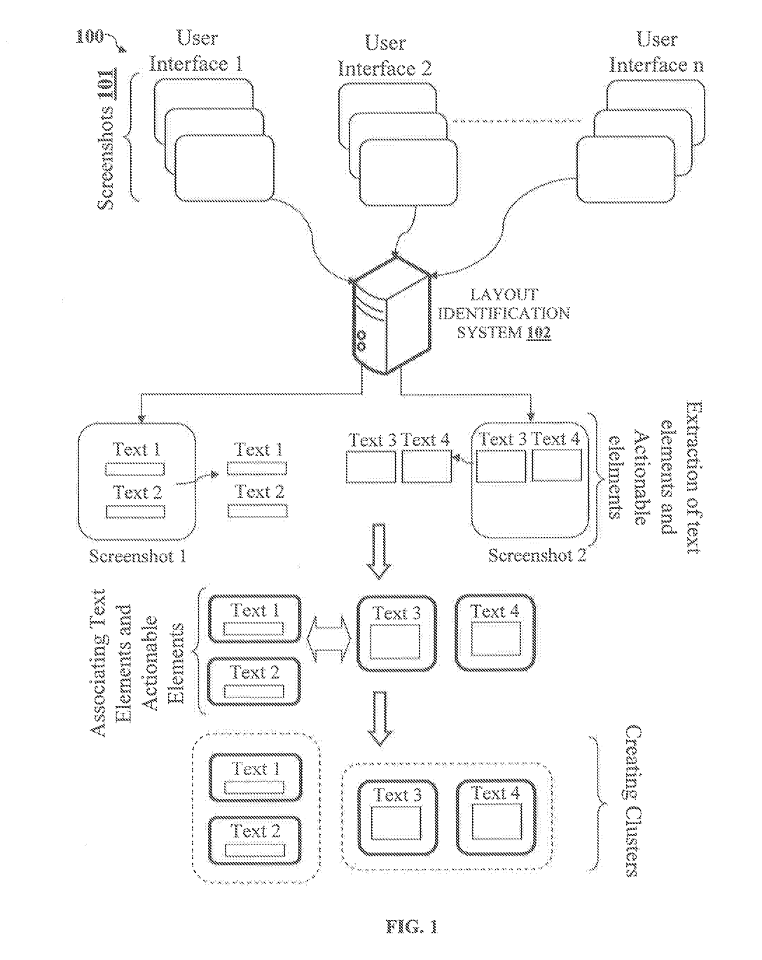

FIG. 1 shows an exemplary environment for facilitating identification of a layout of a user interface in accordance with some embodiments of the present disclosure.

The environment 100 includes user interfaces (User Interface 1, User Interface 2, and User interface 3), a plurality of screenshots 101 and a layout identification system 102. The plurality of screenshots 101 belong to their corresponding user interfaces associated with different applications. For example, user interface of online travel applications may include login page, source-destination selection page, travel date selection page, seat selection page and payment option page. The screenshots of each of these pages (i.e., user interfaces) are received by the layout identification system 102. Post receiving the screenshots, the layout identification system 102 extracts text elements and actionable elements.

As an example, two screenshots of different applications have been shown in FIG. 1, in which, text elements like Text 1 and Text 2 from Screenshot 1 and text elements Text 3 and Text 4 from Screenshot 2 is fetched. Further, the actionable elements shown as rectangular and square boxes are also fetched along with the text elements. The layout identification system 102 further associate the text elements with the actionable elements of the two screenshots. Post association, the layout identification system 102 binds the combination of text elements and actionable elements into clusters. The clustering helps the layout identification system 102 understand about the sequence of the text elements and the actionable elements. Based on the clustering and association, the layout identification system 102 also learns about the similarity between the text elements and actionable elements of one user interface with another user interface. Based on the learning, the layout identification system 102 trains itself about the combination of the text elements and the actionable elements which is implemented while identifying the layout of new user interfaces.

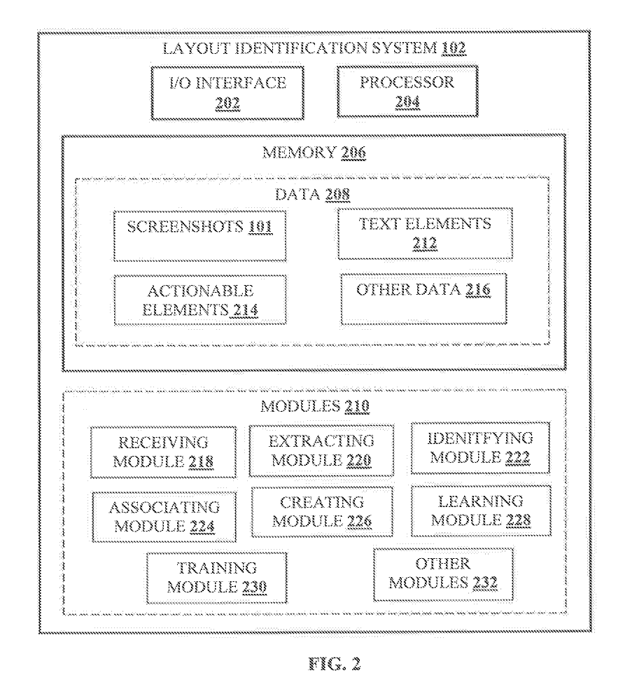

FIG. 2 shows a detailed block diagram illustrating a layout identification system, for facilitating identification of a layout of a user interface in accordance with some embodiments of the present disclosure.

The layout identification system 102 includes an I/O interface 202, a processor 204, and a memory 206. The I/O Interface 202 may be configured to receive a plurality of screenshots 101 of the user interfaces. The memory 206 may be communicatively coupled to the processor 204. The processor 204 may be configured to perform one or more functions of the layout identification system 102 for facilitating layout identification of user interfaces. In one implementation, the layout identification system 102 may include data 208 and modules 210 for performing various operations in accordance with the embodiments of the present disclosure. In an embodiment, the data 208 may be stored within the memory 2116 and may include, without limiting to, screenshots 101, text elements 212, actionable elements 214, and other data 216.

In some embodiments, the data 208 may be stored within the memory 206 in the form of various data structures. Additionally, the data 208 may be organized using data models, such as relational or hierarchical data models. The other data 216 may store data, including temporary data and temporary files, generated by the modules 210 for performing the various functions of the layout identification system 102.

In an embodiment, the screenshots 101 may be images of different phases of the application. Considering an example of online travel application, the screenshots 101 may include images of login page, source-destination selection page, date selection page, seat selection page, payment option page and the like. There may be other examples of the application which may include application related to login screens and SAP applications.

In an embodiment, the text elements 212 may include elements like text labels, anchor links, paragraphs and the like. In an embodiment, the actionable elements 214 may include graphical elements like radio buttons, check boxes, menu, submenus, text boxes, drop boxes, icons and the like.

In some embodiments, the data 208 may be processed by one or more modules 210 of the layout identification system 102. In one implementation, the one or more modules 210 may be stored as a part of the processor 204. In another implementation, the one or more modules 2111 may be communicatively coupled to the processor 204 for performing one or more functions of the layout identification system 102. The modules 210 may include, without limiting to, a receiving module 218, an extracting module 220, an identifying module 222, an associating module 224, a creating module 226, a learning module 228, a training module 230, and other modules 232.

As used herein, the term ‘module’ refers to an application specific integrated circuit (ASIC), an electronic circuit, a processor (shared, dedicated, or group) and memory that execute one or more software or firmware programs, a combinational logic circuit, and/or other suitable components that provide the described functionality. In an embodiment, the other modules 232 may be used to perform various miscellaneous functionalities of the layout identification system 102. It will be appreciated that such modules 210 may be represented as a single module or a combination of different modules.

In an embodiment, the receiving module 218 may receive a plurality of screenshots 101 of plurality of user-interfaces associated with one or more applications. As described above, the screenshots are the collections of images of various pages of the application. In other words, each screenshot indicates a phase associated with a workflow of the application. For example, while booking a ticket on the online ticketing application, user has to navigate through the various pages like login page where the user input user-id and password, source-destination selection page where the user selects his/her preferred source and the destination of travel plan, date selection page where the user has to select dates of the travel, seat selection page where the user selects his/her preferred seat and payment page where the user makes the payment.

According to embodiments of present disclosure, the layout identification system automates the above discussed user steps 102. For example, the layout identification system 102 may fetch the travel details from an email or any user document and automatically populates the details on their corresponding fields of the application. However, when a new user interface is encountered, it becomes a challenge for the layout identification system 102 to understand the layout of the new user interface. The new user interface may belong to a new online travel application for which the automation has to be implemented. Though, the new user interface has the similar functionality, however the layout may be different. To address this challenge, the layout identification system 162 performs various operations as described in subsequent paragraphs of the specification,

Once the plurality of screenshots 161 is received, in next step, the extracting module 220 extracts one or more text elements 212 and one or more corresponding actionable elements 214 from each screenshot of the plurality of screenshots 101. For extracting the text elements 212 and the actionable elements 214, the layout identification system 102 performs Image processing techniques. In first step, the layout identification system 102 may convert the plurality of screenshots 101 into a binary image by using adaptive binarization. From the binary image, the layout identification system 102 identifies contours in order to detect regions outlined against background of the binary image. Further, a text detection technique and an optical character recognition technique is applied upon the detected regions outlined against background in order to recognize the one or more text elements 212.

Now for extracting the actionable elements 214, the layout identification system 102 segments the plurality of screenshots 101 into one or more overlapping patches. These one or more overlapping patches is passed through a segmentation model in order to generate one or more segmented images. Further, layout identification system 162 merges the one or more segmented images for generating a single image. Further, a stitching technique is applied upon the single image to extract the actionable elements 214.

Now in next step, the identifying module 222 of the layout identification system 162 identifies properties of the one or more actionable elements 214 present in each of the plurality of screenshots 101. The properties indicate functionality of the one or more actionable elements 214. For example, the properties of the actionable elements may include text enabled, text disabled, cheeked, unchecked and the like. This helps the layout identification system 102 understand about the nature of the actionable elements. With such understanding, the layout identification system 102 also learns how different looking actionable elements may behave in a similar manner.

Now once the properties are identified, next step is to correlate the text elements with actionable elements. However, the correlating or associating may be performed across the screenshots associated with different user interfaces. For example, the associating module 224 of the layout identification system 102 may associate the one or more text elements, of one screenshot associated with one of the plurality of user-interfaces, with the one or more actionable elements, of another screenshot associated with, another user-interface of the plurality of user-interfaces, based on the properties. Referring back to FIG. 1, the actionable elements of two different forms can be observed. One is a rectangular box (at left hand side), whereas the other is a square box (at right hand side). Though, both the actionable elements represent a same functionality i.e., allowing users to input login-id and passwords, but the location and size of both the actionable elements is visually different. However, when the association is performed, the layout identification system 102 understand about the intuitiveness in their design and update itself accordingly.

Now, in next step, the creating module 226 of the layout identification system 102 creates one or more clusters of the one or more text elements and the one or more actionable elements based on the association. The generation of the one or more clusters facilitates in identification of the layout of the user interface. The clusters are shown in FIG. 1 as dotted lines which combines the text elements 212 and the actionable elements 214 together. The clustering helps the layout identification system 102 to understand, about the different sections on the screen. Based on the generation of the clusters, the learning module 228 of the layout identification system 102 learns about similarity between the one or more actionable elements, of the one user-interface, with the one or more actionable elements, of another user-interface. Further, the training module 230 trains the layout identification system 102 based on the learning for identifying a layout of a new user interface. Thus, whenever new interface is encountered for automation, the layout identification system 102 automatically identifies the layout of that user interface and performs automation without modifying the source code of user interface.

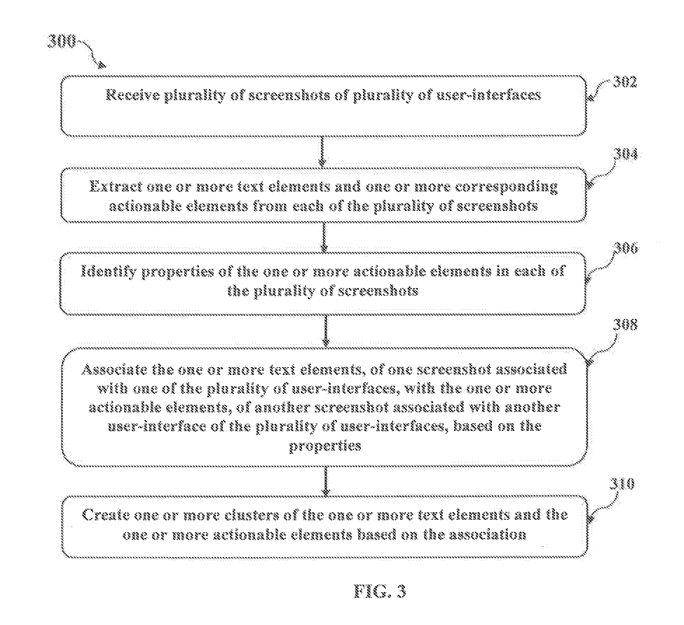

FIG. 3 shows a flowchart illustrating a method of facilitating identification of a layout of a user interface in accordance with some embodiments of the present disclosure.

As illustrated in FIG. 3, the method 300 includes one or more blocks illustrating a method of facilitating identification of a layout of a user interface using layout identification system 102. The method 300 may be described in the general context of computer executable instructions. Generally, computer executable instructions can include routines, programs, objects, components, data, structures, procedures, modules, and functions, which perform specific functions or implement specific abstract data types.

The order in winch the method 300 is described Is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 302, the method 300 includes receiving, by a layout identification system 102, plurality of screenshots 101 of plurality of user-interfaces. Further, each screenshot of the plurality of screenshots 101 indicate a phase associated with a workflow of an application.

At block 304, the method 300 includes extracting, by the layout identification system 102, one or more text elements 212 and one or more corresponding actionable elements 214 from each of the plurality of screenshots 101. According to an embodiment, the one or more text elements 212 includes at least one of text labels, anchor links and paragraphs. Further, according to an embodiment, the one or more corresponding actionable elements 214 includes at least one of radio buttons, check boxes, menu, submenus, text boxes, drop boxes and icons.

At block 306, the method 300 includes identifying, by the layout identification system 102, properties of the one or more actionable elements 214 in each of the plurality of screenshots 101. The properties indicate functionality of the one or more actionable elements 214.

At block 308, the method 300 includes associating, by the layout identification system 102, the one or more text elements 212, of one screenshot associated with one of the plurality of user-interfaces, with the one or more actionable elements 214, of another screenshot associated with another user-interface of the plurality of user-interfaces, based on the properties.

At block 310, the method 300 includes creating, by the layout identification system 102, one or more clusters of the one or more text elements 212 and the one or more actionable elements 214 based on the association. The one or more clusters facilitates in identification of the layout of the user interface.

### Computer System

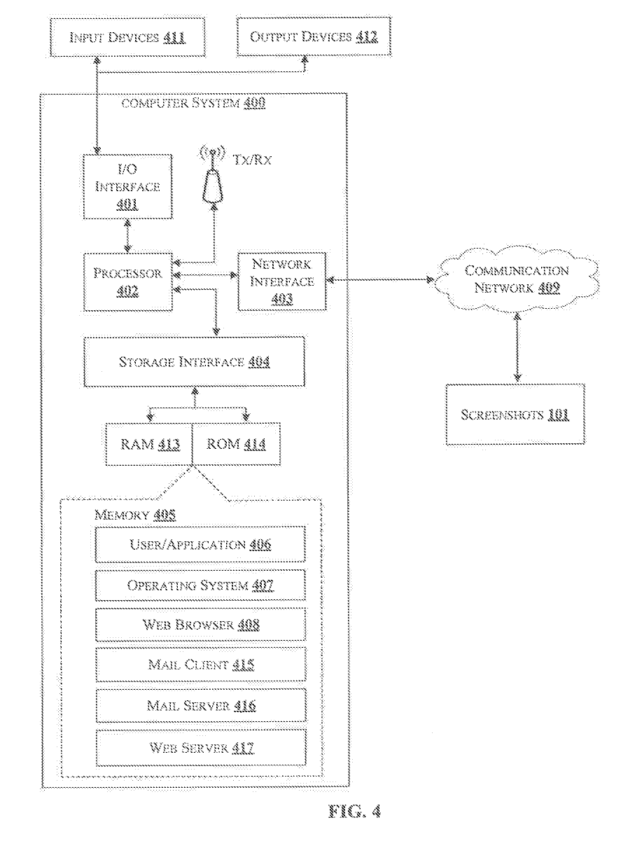

FIG. 4 illustrates a block diagram of an exemplary computer system for implementing embodiments consistent with the present disclosure. In an embodiment, the computer system 400 may be the layout identification system 102 which is used for facilitating identification of a layout of a user interface. The computer system 400 may include a central processing unit (“CPU” or “processor”) 402. The processor 402 may comprise at least one data processor for executing program components for executing user- or system-generated business processes. A user may include a person, a person using a device such as such as those included in this invention, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc.

Using the I/O interface 401, the computer system 400 may communicate with one or more I/O devices (411 and 412). In some embodiments, the processor 402 may be disposed, in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc.

In some embodiments, the processor 402 may be disposed in communication with, a memory 405 (e.g., RAM 413, ROM 414, etc. as shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel. Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application 406, an operating system 407, web browser 408 etc. In some embodiments, computer system 400 may store user/application data 406, such as the data, variables, records, etc, as described in this invention. Such databases may be implemented, as fault-tolerant, relational, scalable, secure databases such as Oracle or Sybase.

The operating system 407 may facilitate resource management and operation of the computer system 400. Examples of operating systems include, without limitation, Apple Macintosh OS X, UNIX, Unix-like system distributions (e.g., Berkeley Software Distribution (BSD), FreeBSD, Net BSD, Open BSD, etc.), Linux distributions (e.g., Red Hat, Ubuntu, K-Ubuntu, etc.), International Business Machines (IBM) OS/2, Microsoft Windows (XP, Vista/7/8, etc.), Apple iOS, Google Android, Blackberry Operating System (OS), or the like. A user interlace may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, JavaScript, AJAX, HTML, Adobe Flash, etc,), or the like.

In some embodiments, the computer system 400 may implement a web browser 408. The web browser 408 may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the computer system 400 may implement a mail server stored program, component. The mail server 416 may be an Internet mail server such, as Microsoft Exchange, or the like. The mail server 416 may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the computer system 400 may implement a mail client 415. The mail client 415 may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiment of the Present Disclosure are Illustrated Herein

In an embodiment, the present disclosure provides a method for facilitating identification of a layout of a user interface without modifying its source code.

In an embodiment, the identification of the layout of the user interface is performed without exposing enterprise data to a third party.

In an embodiment, the identification of the layout of the user interface also reduces the load or effort of modifying the source code of the application.

In an embodiment, the method of the present disclosure helps in reducing the management overheads by providing end-to-end management of the security threats.

In an embodiment, since the method depends only on screenshots of the user interfaces as input, the method Is compatible with any platform from desktop to smartphones and on any operating system that supports the graphical user interface.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified, otherwise.

The enumerated listing of items does not imply that any or all the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are Intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

| Reference Number | Description |
|---|---|
| 100 | ENVIRONMENT |
| 101 | SCREENSHOTS |
| 102 | LAYOUT IDENTIFICATION SYSTEM |
| 202 | I/O INTERFACE |
| 204 | PROCESSOR |
| 206 | MEMORY |
| 208 | DATA |
| 210 | MODULES |
| 212 | TEXT ELEMENTS |
| 214 | ACTIONABLE ELEMENTS |
| 216 | OTHER DATA |
| 218 | RECEIVING MODULE |
| 220 | EXTRACTING MODULE |
| 222 | IDENITFYING MODULE |
| 224 | ASSOCIATING MODULE |
| 226 | CREATING MODULE |
| 228 | LEARNING MODULE |
| 230 | TRAINING MODULE |
| 232 | OTHER MODULES |

1. A method of facilitating identification of a layout of a user interface, the method comprising:
receiving, by a layout identification system, plurality of screenshots of plurality of user-interfaces, wherein each screenshot of the plurality of screenshots Indicate a phase associated with a workflow of an application;
extracting, by the layout identification system, one or more text elements and one or more corresponding actionable elements from each of the plurality of screenshots;
identifying, by the layout identification system, properties of the one or more actionable elements in each of the plurality of screenshots, wherein the properties indicates functionality of the one or more actionable elements;
associating, by the layout identification system, the one or more text elements, of one screenshot associated with one of the plurality of user-interfaces, with the one or more actionable elements, of another screenshot associated with another user-interface of the plurality of user-interfaces, based on the properties; and
creating, by the layout identification system, one or more clusters of the one or snore text elements and the one or more actionable elements based on the association, wherein the one or more clusters facilitates in identification of the layout of the user interlace.

2. The method as claimed in claim 1, wherein:
the one or more text elements comprises at least one of text labels, anchor links and paragraphs, and
the one or more corresponding actionable elements comprises at least one of radio buttons, check boxes, menu, submenus, text boxes, drop boxes and icons.

3. The method as claimed in claim 1, wherein the properties comprises at least one of a text enabled, text disabled, checked, and unchecked associated with the one or more corresponding actionable elements.

4. The method as claimed in claim 1, further comprising learning about similarity between the one or more actionable elements, of the one user-interface, with the one or more actionable elements, of another user-interface, based on the one or more clusters.

5. The method as claimed in claim 4, farther comprising training the layout identification system based on the learning for identifying a layout of a new user interface.

6. The method as claimed in claim 1, further comprising automating the application based on the identification of the layout of the user interface, wherein the application comprises at least one of an online ticketing application, login screens, and SAP applications.

7. The method as claimed in claim 1, wherein the one or more text elements are extracted by:
converting the plurality of screenshots into a binary image by using adaptive binarization,
identifying contours from, the binary image in order to detect regions outlined against background of the binary image, and
applying a text detection technique and an optical character recognition technique upon the regions outlined against background in order to recognize the one or more text elements.

8. The method as claimed in claim 1, wherein the one or more actionable elements axe extracted by:
segmenting the plurality of screenshots into one or more overlapping patches, passing the one or more overlapping patches through a segmentation model in order to generate one or more segmented images,
generating a single image by merging the one or more segmented images, and applying a stitching technique upon the single image.

9. A layout identification system for facilitating Identification of a layout of a user interface, the system comprising:
a processor; and
a memory communicatively coupled to the processor, wherein the memory stores processor-executable instructions, which, on execution, causes the processor to:
receive plurality of screenshots of plurality of user-interfaces, wherein each screenshot of the plurality of screenshots indicate a phase associated with a workflow of an application;
extract one or more text elements and one or more corresponding actionable elements from, each of the plurality of screenshots;
identify properties of the one or more actionable elements in each, of the plurality of screenshots, wherein the properties indicate functionality of the one or more actionable elements;
associate the one or more text elements, of one screenshot associated with one of the plurality of user-interfaces, with the one or more actionable elements, of another screenshot associated with another user-interface of the plurality of user-interfaces, based on the properties; and
create one or more clusters of the one or more text elements and the one or more actionable elements based on the association, wherein the one or more clusters facilitates in identification of the layout of the user interface.

10. The layout identification system as claimed in claim 9, wherein:
the one or more text elements comprises at least one of text labels, anchor links and paragraphs, and
the one or more corresponding actionable elements comprises at least one of radio buttons, check boxes, menu, submenus, text boxes, drop boxes and icons.

11. The layout identification system as claimed in claim 9, wherein the properties comprises at least one of a text enabled, text disabled, checked, and unchecked associated with the one or more corresponding actionable elements.

12. The layout identification system as claimed in claim 9, is configured to learn about similarity between the one or more actionable elements, of the one user-interface, with the one or more actionable elements, of another user-interface, based on the one or more clusters.

13. The layout identification system as claimed in claim 12, is further configured to be trained, based on the learning, for identifying a layout of a new user interface.

14. The layout identification system as claimed in claim 9, is further configured to automate the application based on the identification of the layout of the user interface, wherein the application comprises at least one of an online ticketing application, login screens, and SAP applications.

15. The layout identification system as claimed in claim 9, extracts the one or more text elements by:
converting the plurality of screenshots into a binary image by using adaptive binarization, identifying contours from the binary image in order to detect regions outlined against background of the binary image, and
applying a text detection technique and an optical character recognition technique upon the regions outlined against background in order to recognize the one or more text elements.

16. The layout identification system as claimed in claim 9, extracts the one or more actionable elements by:
segmenting the plurality of screenshots into one or more overlapping patches, passing the one or more overlapping patches through a segmentation model in order to generate one or more segmented images,
generating a single image by merging the one or more segmented images, and applying a stitching technique upon the single image.

17. A non-transitory computer-readable storage medium including instructions stored thereon that when processed by at least one processor cause a layout identification system to perform operations comprising:
receiving plurality of screenshots of plurality of user-interfaces, wherein each screenshot of the plurality of screenshots indicate a phase associated with a workflow of an application;
extracting one or more text elements and one or more corresponding actionable elements from each of the plurality of screenshots;
identifying properties of the one or more actionable elements in each of the plurality of screenshots, wherein the properties indicates functionality of the one or more actionable elements;
associating the one or more text elements, of one screenshot associated with one of the plurality of user-Interfaces, with the one or more actionable elements, of another screenshot associated with another user-interface of the plurality of user-interfaces, based on the properties; and
creating one or more clusters of the one or more text elements and the one or more actionable elements based on the association, wherein the one or more clusters facilitates in identification of the layout of the user interface.

18. The medium as claimed in claim 17, wherein:
the one or more text elements comprises at least one of text labels, anchor links and paragraphs, and
the one or more corresponding actionable elements comprises at least one of radio buttons, check boxes, menu, submenus, text boxes, drop boxes and icons.

19. The medium as claimed in claim 17, wherein the properties comprises at least one of a text enabled, text disabled, checked, and unchecked associated with the one or more corresponding actionable elements.

20. The medium as claimed in claim 17, wherein the Instructions further cause the at least processor to learn about similarity between the one or more actionable elements, of the one user-interface, with the one or more actionable elements, of another user-interface, based on the one or more clusters.

21. The medium as claimed in claim 20, wherein the instructions further cause the at least processor to train the layout identification system based on the learning for identifying a layout of a new user interface.

22. The medium, as claimed in claim 17, wherein the instructions further cause the at least processor to automate the application based, on the identification of the layout of the user interface, wherein the application comprises at least one of an online ticketing application, login screens, and SAP applications.

23. The medium as claimed in claim 17, the one or more text elements are extracted by:
converting the plurality of screenshots into a binary image by using adaptive binarization,
identifying contours from the binary image in order to detect regions outlined against background of the binary image, and
applying a text detection technique and an optical character recognition technique upon the regions outlined against background, in order to recognize the one or more text elements.

24. The medium as claimed in claim 17, wherein the one or more actionable elements are extracted by:
segmenting the plurality of screenshots into one or more overlapping patches,
passing the one or more overlapping patches through a segmentation model in order to generate one or more segmented images,
generating a single image by merging the one or more segmented images, and
applying a stiching technique upon the single image.
